(19) United States
(12) Patent Application Publication
(10) Pub. No.: US 2008/0079672 A1
(43) Pub. Date: Apr. 3, 2008

(54) DRIVING METHOD FOR A LIQUID CRYSTAL DISPLAY DEVICE AND RELATED DEVICE

(76) Inventor: Chin-Hung Hsu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/567,223

(22) Filed: Dec. 6, 2006

(30) Foreign Application Priority Data
Oct. 2, 2006 (TW) 095136569

(51) Int. Cl. G09G 3/36

(52) U.S. Cl. 345/87

(57) ABSTRACT

A driving method for an LCD device determines whether an Nth image data to be outputted to a pixel in an Nth frame period is different from an (N-1)th image data outputted to the pixel in an (N-1)th frame period. If the Nth image data is different from the (N-1)th image data, the driving method outputs a black image data to the pixel before outputting the Nth image data. If the Nth image data is not different from the (N-1)th image data, the driving method outputs the Nth image data to the pixel.

### BACKGROUND OF THE INVENTION

1. Field of the Invention

The present invention relates to a driving method for an LCD device, and more particularly, to a driving method for an LCD device capable of performing black-pixel insertion.

2. Description of the Prior Art

Liquid crystal display (LCD) devices, characterized in thin appearance, low power consumption and low radiation, have gradually replaced traditional cathode ray tube (CRT) displays and been widely applied in various portable electronic devices, such as notebook computers, personal digital assistants (PDA), digital cameras and digital video recorders. An LCD device displays images of different gray scales by rotating the orientation of the liquid crystal molecules. If the reaction speed of the liquid crystal molecules cannot catch up with the refreshing rate of image data, images of various gray scales cannot be displayed accurately. Due to visual memory of human eyes, image blur is particularly obvious when observing motional images. Therefore, it is important to provide an LCD device capable of displaying images of different gray scales accurately and reducing image blur.

Reference is made to FIG. 1 for a timing diagram illustrating the pixel driving voltage and the corresponding light transmittance in a prior art LCD device. In FIG. 1, C1 and C2 represent the data voltages outputted to a pixel. When the pixel receives the data voltages C1 and C2, the ideal light transmittance is represented by a bold line in FIG. 1, while curve V1 (a dash line in FIG. 1) represents the actual light transmittance of the pixel. Fₙ-Fₙ₊₃ represent continuous frame periods. Assuming in the frame period Fₙ, a pixel of the prior art LCD device has to switch from the data voltage C1 to the data voltage C2. Since the liquid crystal molecules cannot rotate to a predetermined angle corresponding to data voltage C2 immediately in the beginning of the frame period Fₙ due to limited reaction speed, the pixel may fail to provide the predetermined light transmittance in frame period Fₙ. As illustrated by the curve V1 representing the light transmittance in FIG. 1, instead of reaching the predetermined light transmittance in frame period Fₙ as required, the light transmittance V1 reaches the predetermined light transmittance in frame period Fₙ₊₂. This phenomenon results in image blur which largely influences the display quality of the LCD device.

Normally, an over-drive technique is used for driving the LCD device so that image blur can be improved by accelerating the reaction speed of the liquid crystal materials. Reference is made to FIG. 2 for a timing diagram illustrating the pixel driving voltage and the corresponding light transmittance in a prior art LCD device using over-drive technique. In FIG. 2, C1 and C2 represent the data voltages outputted to a pixel. When the pixel receives the data voltages C1 and C2, the curve corresponding to the ideal light transmittance is depicted by a bold line in FIG. 2. C3 represents the over-drive data voltage outputted to the pixel. When the pixel receives the over-drive data voltage C3, the curve corresponding to the ideal light transmittance is also depicted by a corresponding bold line in FIG. 2. A curve V2 represents the actual light transmittance of the pixel, as illustrated by a dash line in FIG. 2. Fₙ and Fₙ₊₁ represent two continuous frame periods. Assuming in the frame period Fₙ, a pixel of the prior art LCD device has to switch from the data voltage C1 to the data voltage C2. Under these circumstances, the over-drive data voltage C3 is applied to the pixel for accelerating the reaction speed of the liquid crystal materials. As illustrated in FIG. 2, the liquid crystal materials have a faster reaction speed since the over-drive data voltage C3 is higher than the data voltage C2. Consequently, the pixel can rotate to a predetermined angle corresponding to the data voltage C2 and provide the predetermined light transmittance in frame period Fₙ, as illustrated by the curve V2 in FIG. 2.

Though an LCD device using over-drive technique can improve the accuracy in gray pixel displays, human eyes still observe image blur due to visual memory. Normally, black frame insertion technique is used for displaying black images between each frame period. Therefore, similar to the impulse type of CRTs, the perceivable image blur can be reduced. Reference is made to FIG. 3 for a diagram illustrating a prior art method for improving image blur using black frame insertion technique. In FIG. 3, P₁-Pₙ represent the normal images displayed by a prior art LCD device at T₁-Tₙ, and B₁-Bₙ represent black images. In order to reduce image blur of the prior art LCD device, a black image is displayed between the normal image of a frame period and the normal image of the next frame period. In other words, the prior art method sequentially displays the images in the sequence of P₁-B₁-P₂-B₂- . . . -Pₙ-Bₙ.

In the prior art method for reducing image blur as illustrated in FIG. 3, the brightness of the LCD device is lowered since each frame period has to include a sub-frame for displaying a black image. With the black images B₁-Bₙ displayed interleavely between the corresponding images P₁-Pₙ, a viewer perceives the images P₁-Pₙ with a lower brightness. Therefore, though the prior art method can reduce image blur, the brightness of the LCD device is greatly reduced and the display quality is thus affected.

Reference is made to FIG. 4 for a diagram illustrating the image brightness of a prior art LCD device using over-drive technique. In FIG. 4, the horizontal axis represents time, the vertical axis represents the brightness of the images displayed by the LCD device, and F₁-F₆ represent 6 frame periods. When the images to be displayed in each of the frame periods F₁, F₂, F₅ and F₆ have a first gray scale, the ideal image brightness of a pixel is represented by I₁. When the images to be displayed in each of the frame periods F₃ and F₄ have a second gray scale larger than the first gray scale, the ideal image brightness of a pixel is represented by I₂. In other words, the ideal brightness of the pixel to be displayed in the frame periods F₁, F₂, F₃, F₄, F₅ and F₆ are respectively represented by I₁, I₁, I₂, I₂, I₁ and I₁, and the curve corresponding to the ideal brightness is illustrated by a dash line in FIG. 4. Since the pixel displays images having distinct gray scales in two continuous frame periods F₂ and F₃, an over-drive data voltage higher than the ideal data voltage is applied at T₂ so that the image brightness can be raised from I₁ to I₂ quickly. Similarly, since the pixel displays images having distinct gray scales in two continuous frame periods F₄ and F₅, an over-drive data voltage lower than the ideal data voltage is applied at T₄ so that the image brightness can be lowered from I₂ to I₁ quickly.

Reference is made to FIG. 5 for a diagram illustrating the image brightness of a prior art LCD device using black frame insertion technique. In FIG. 5, the horizontal axis represents time, the vertical axis represents the brightness of the images displayed by the LCD device, and F₁-F₆ represent 6 frame periods. When the images to be displayed in each of the frame periods F₁, F₂, F₅ and F₆ have a first gray scale, the ideal image brightness of a pixel is represented by I₁. When the images to be displayed in each of the frame periods F₃ and F₄ have a second gray scale larger than the first gray scale, the ideal image brightness of a pixel is represented by I₂. In other words, the ideal brightness of the images to be displayed in the frame periods F₁, F₂, F₃, F₄, F₅ and F₆ are respectively represented by I₁, I₁, I₂, I₂, I₁ and I₁, and the curve corresponding to the ideal brightness is illustrated by a dash line in FIG. 5. In order to reduce image blur, the pixel also displays a black image after the normal image in each frame period. Therefore, the image brightness of the pixel at T₁-T₆ is much lower than the corresponding ideal value, as illustrated in FIG. 5.

In the prior art, black image insertion technique is used for driving an LCD device on a per-scan-line basis. Black image data are inserted in each frame period regardless of the gray scale variations of display images. Therefore, though the prior art method can reduce image blur, the brightness of the LCD device is greatly reduced and the display quality is thus affected.

### SUMMARY OF THE INVENTION

The present invention provides a method for driving a liquid crystal display device comprising determining whether an Nth image data to be outputted to a pixel in an Nth frame period is different from an (N-1 )th image data outputted to the pixel in an (N-1)th frame period; outputting a black image data to the pixel before outputting the Nth image data to the pixel when a difference between the Nth image data and the (N-1)th image data is larger than a predetermined value; and outputting the Nth image data to the pixel when the difference between the Nth image data and the (N-1)th image data is not larger than the predetermined value.

The present invention also provides an LCD device capable of performing black-pixel insertion comprising a first memory means for storing image data outputted to a pixel in each frame period; a comparing means for receiving an Nth image data corresponding to images to be displayed by the pixel in an Nth frame period, accessing an (N-1)th image data corresponding to images displayed by the pixel in an (N-1)th frame period, and determining whether the Nth image data is different from the (N-1)th image data; and a black-pixel insertion operating means for outputting the Nth image data to the pixel when the Nth image data is close to the (N-1)th image data, and outputting the Nth image data and a black image data to the pixel when the Nth image data is different from the (N-1)th image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram illustrating the pixel driving voltage and the corresponding light transmittance in a prior art LCD device.

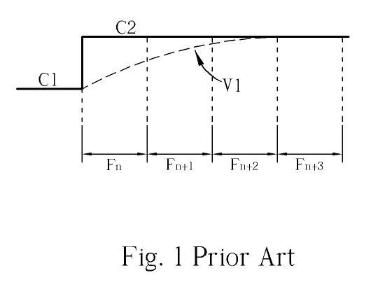

FIG. 2 is a timing diagram illustrating the pixel driving voltage and the corresponding light transmittance in a prior art LCD device using over-drive technique.

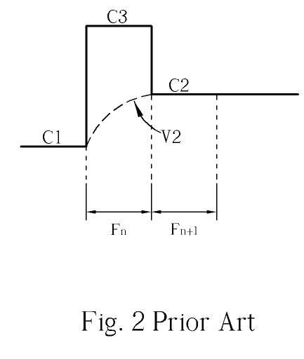

FIG. 3 is a diagram illustrating a prior art method for improving image blur using black frame insertion technique.

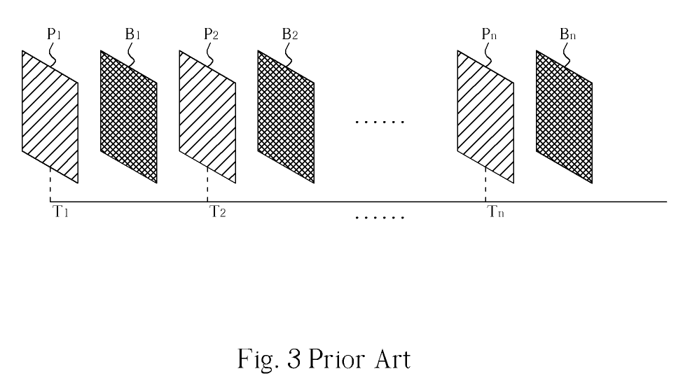

FIG. 4 is a diagram illustrating the image brightness of a prior art LCD device using over-drive technique.

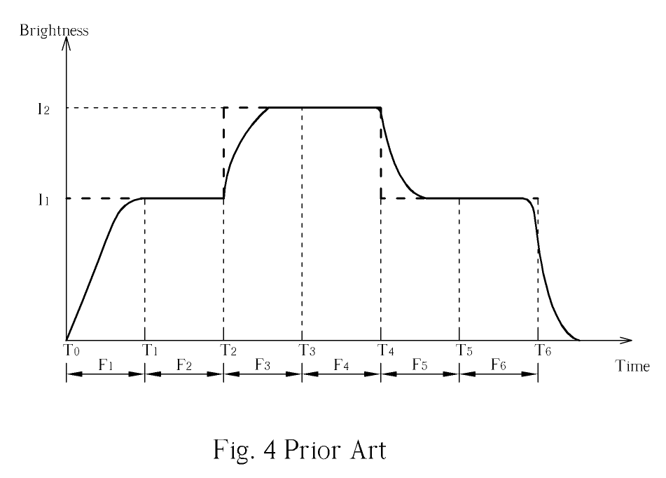

FIG. 5 is a diagram illustrating the image brightness of a prior art LCD device using black frame insertion technique.

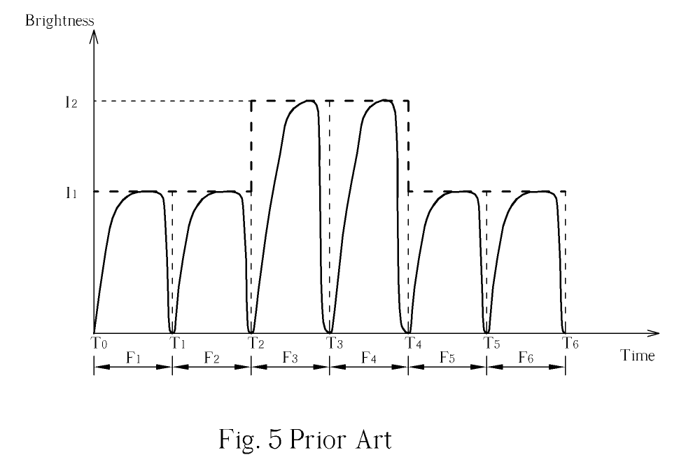

FIG. 6 is a flowchart illustrating a method for driving an LCD device according to a first embodiment of the present invention.

FIG. 7 is a diagram illustrating the image brightness of an LCD device according to the first embodiment of the present invention.

FIG. 8 is a flowchart illustrating a method for driving an LCD device according to a second embodiment of the present invention.

FIG. 9 is a functional diagram of an image data generator according to the present invention.

FIG. 10 is a functional diagram of an LCD device according to the present invention.

### DETAILED DESCRIPTION

In the present invention, black pixel insertion is used for driving an LCD device. Black images are displayed on a per-pixel basis and based on gray scale variations of the images displayed by a pixel in each frame period.

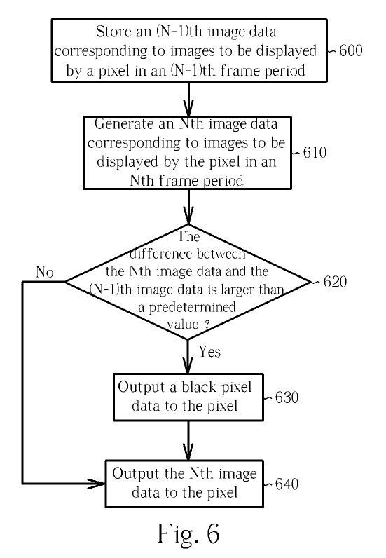

Reference is made to FIG. 6 for a flowchart illustrating a method for driving an LCD device according to a first embodiment of the present invention. The flowchart in FIG. 6 includes the following steps:

Step 600: store an (N-1)th image data corresponding to images to be displayed by a pixel in an (N-1)th frame period.

Step 610: generate an Nth image data corresponding to images to be displayed by the pixel in an Nth frame period.

Step 620: determine whether the Nth image data is different from the (N-1)th image data: if the difference between the Nth image data and the (N-1)th image data is larger than a predetermined value, execute step 630; if the difference between the Nth image data and the (N-1)th image data is not larger than the predetermined value, execute step 640.

Step 630: output a black pixel data to the pixel; execute step 640.

Step 640: output the Nth image data to the pixel.

In the first embodiment of the present invention, the (N-1)th image data corresponding to the images to be displayed by the pixel in the (N-1)th frame period is stored in step 600. Based on the images to be displayed by the pixel in the Nth frame period, the Nth image data is generated in step 610. Before outputting the Nth image data to the pixel, it is determined in step 620 whether the Nth image data is different from the (N-1)th image data. If the current image data largely differs from the prior image data, the difference between the Nth image data and the (N-1)th image data is larger than the predetermined value, and black pixel insertion is executed in step 630 for outputting a black pixel data to the pixel. If the difference between the Nth image data and the (N-1)th image data is not larger than the predetermined value, black pixel insertion is not executed. Instead, the Nth image data is outputted to the pixel in step 640.

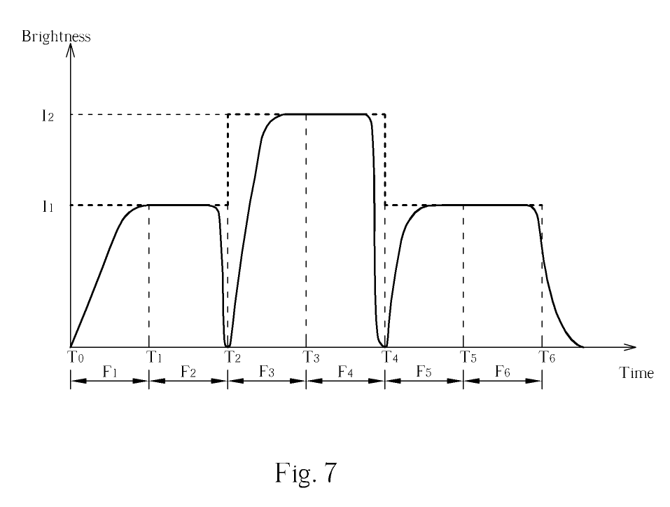

Reference is made to FIG. 7 for a diagram illustrating the image brightness of an LCD device according to the first embodiment of the present invention. In FIG. 7, the horizontal axis represents time, the vertical axis represents the brightness of the images displayed by the LCD device, and F₁-F₆ represent 6 frame periods. When a pixel to be displayed in each of the frame periods F₁, F₂, F₅ and F₆ have a first gray scale, the ideal image brightness of a pixel is represented by I₁. When the pixel to be displayed in each of the frame periods F₃ and F₄ have a second gray scale larger than the first gray scale, the ideal image brightness of the pixel is represented by I₂. In other words, the ideal brightness of the pixel to be displayed in the frame periods F₁, F₂, F₃, F₄, F₅ and F₆ are respectively represented by I₁, I₁, I₂, I₂, I₁ and I₁, and the curve corresponding to the ideal brightness is illustrated by a dash line in FIG. 7. When the pixel displays images having distinct gray scales in two continuous frame periods (such as in the frame periods F₂ and F₃, or in the frame periods F₄ and F₅), black pixel insertion is executed in the first embodiment of the present invention. Therefore, the image brightness of the pixel at T₂ and T₄ is lower than the corresponding ideal value. When the pixel displays images having a close gray scale in two continuous frame periods (such as in the frame periods F₁ and F₂, in the frame periods F₃ and F₄, or in the frame periods F₅ and F₆), black pixel insertion is not executed in the first embodiment of the present invention. Therefore, the image brightness of the pixel at T₁, T₃ and T₅ is close to the corresponding ideal value. In the first embodiment of the present invention, black pixel insertion is executed only when the variation in gray scale of the images displayed in two continuous frame periods is larger than the predetermined value. As a result, the present invention can reduce image blur without largely lowering the brightness of the LCD panel.

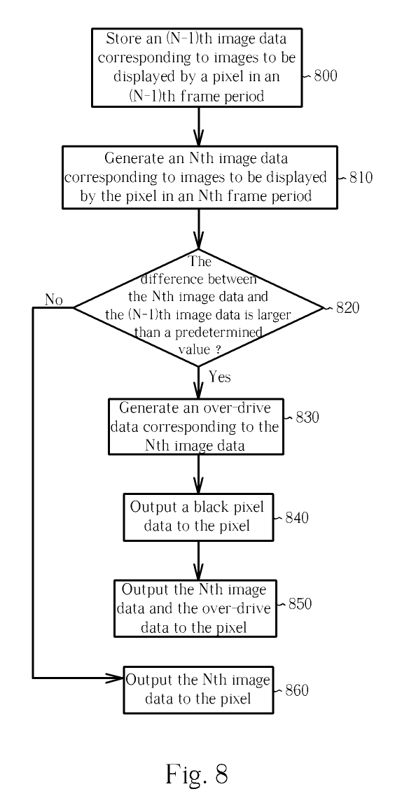

Reference is made to FIG. 8 for a flowchart illustrating a method for driving an LCD device according to a second embodiment of the present invention. The flowchart in FIG. 8 includes the following steps:

Step 800: store an (N-1)th image data corresponding to images to be displayed by a pixel in an (N-1)th frame period.

Step 810: generate an Nth image data corresponding to images to be displayed by the pixel in an Nth frame period.

Step 820: determine whether the Nth image data is different from the (N-1)th image data: if the difference between the Nth image data and the (N-1)th image data is larger than a predetermined value, execute step 830; if the difference between the Nth image data and the (N-1)th image data is not larger than the predetermined value, execute step 860.

Step 830: generate an over-drive data corresponding to the Nth image data; execute step 840.

Step 840: output a black pixel data to the pixel; execute step 850.

Step 850: output the Nth image data and the over-drive data to the pixel.

Step 860: output the Nth image data to the pixel.

Compared to the first embodiment, the second embodiment of the present invention further generates an over-drive data corresponding to the Nth image data in step 830 when it is determined in step 820 that the difference between the Nth image data and the (N-1)th image data is larger than the predetermined value. Also, after outputting the black pixel data to the pixel in step 840, the second embodiment of the present invention outputs the Nth image data and the over-drive data to the pixel in step 850. Also referring to FIG. 7, when the pixel displays images having distinct gray scales in two continuous frame periods (such as in the frame periods F₂ and F₃, or in the frame periods F₄ and F₅), the second embodiment of the present invention first performs black pixel insertion before outputting the over-drive data. Therefore, the image brightness at T₂ can be raised from I₁ to I₂ as soon as possible, while the image brightness at T₄ can be lowered from I₂ to I₁ as soon as possible. In the second embodiment of the present invention, black pixel insertion and over drive techniques are executed only when the variation in gray scale of the images displayed in two continuous frame periods is larger than the predetermined value. As a result, the present invention can reduce image blur without largely lowering the brightness of the LCD panel.

In the first and second embodiments of the present invention, black pixel insertion of the highest gray scale can be performed at T₂ and T₄, as well as black pixel insertion of other lower gray scales.

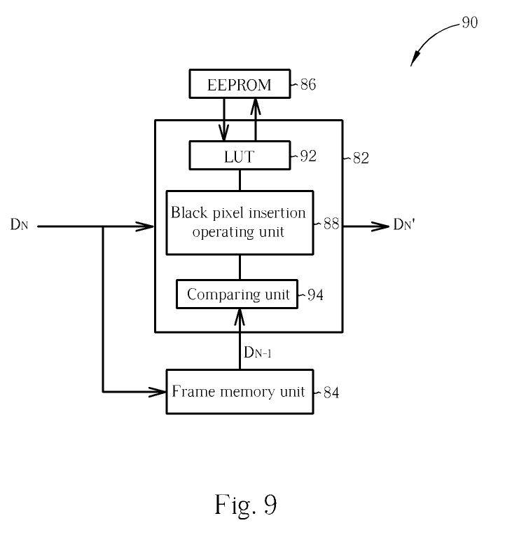

Reference is made to FIG. 9 for a functional diagram of an image data generator 90 according to the present invention. The image data generator 90 includes a driving circuit 82, a frame memory unit 84, and an electrically erasable programmable read-only memory (EEPROM) 86. The driving circuit 82 includes a black pixel insertion operating unit 88 and a comparing unit 94. Image data outputted to the pixel during each frame period is stored in the frame memory unit 84. Based on the images to be displayed by a pixel in an Nth frame period, the image data generator 90 generates a corresponding image data D_{N}, which is then sent to the frame memory unit 84 and the driving circuit 82. After accessing the frame memory unit 84 for an image data D_{N-1} corresponding to the images displayed by the pixel in an (N-1)th frame period, the comparing unit 94 of the driving circuit 82 determines whether the difference between the image data D_{N} and the image data D_{N-1} is larger than a predetermined value. Based on the results obtained from the comparing unit 94, the black pixel insertion operating unit 88 of the driving circuit 82 determines whether an image data D_{N}′ to be outputted to the pixel need to include black pixel data. Also, the EEPROM 86 and a lookup table (LUT) 92 stored in the driving circuit 82 include data for performing over-drive operations. Based on the image data D_{N}, corresponding over-drive voltages can be provided to the driving circuit 82.

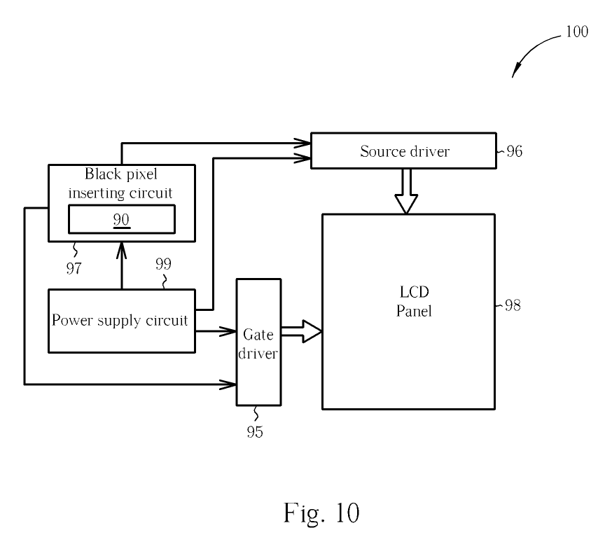

Reference is made to FIG. 10 for a functional diagram of an LCD device 100 according to the present invention. The LCD device 100 includes a gate driver 95, a source driver 96, a black pixel inserting circuit 97, an LCD panel 98, and a power supply circuit 99. The power supply circuit 99 can provide power for operating the gate driver 95, the source driver 96 and the black pixel inserting circuit 97. The black pixel inserting circuit 97 can include the functions of a timing generator and the image data generator 90 illustrated in FIG. 9. Based on the difference between the display images in the current and prior frame periods, corresponding source driving signals can be outputted to the source driver 96. Based on the source driving signals, the source driver 96 outputs image data with or without black image data to the pixel.

The present invention determines whether black pixel insertion and over-drive need to be executed based on gray scale variations of the images displayed by a pixel in each frame period. As a result, the present invention can reduce image blur without largely lowering the brightness of the LCD panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for driving a liquid crystal display (LCD) device comprising:
determining whether an Nth image data to be outputted to a pixel in an Nth frame period is different from an (N-1)th image data outputted to the pixel in an (N-1)th frame period;
outputting a black image data to the pixel before outputting the Nth image data to the pixel when a difference between the Nth image data and the (N-1)th image data is larger than a predetermined value; and
outputting the Nth image data to the pixel when the difference between the Nth image data and the (N-1)th image data is not larger than the predetermined value.

2. The method of claim 1 further comprising:
comparing the Nth image data with the (N-1)th image data.

3. The method of claim 2 further comprising:
storing the (N-1)th image data.

4. The method of claim 3 further comprising:
accessing the (N-1)th image data for comparing the (N-1)th image data with the Nth image data.

5. The method of claim 1 further comprising:
generating the Nth and the (N-1)th image data.

6. The method of claim 1 further comprising:
outputting the Nth image data to the pixel after outputting the black image data to the pixel.

7. The method of claim 1 further comprising:
generating an over-drive data corresponding to the Nth image data when the Nth image data is different from the (N-1)th image data.

8. The method of claim 7 further comprising:
outputting the Nth image data and the over-drive data to the pixel.

9. An LCD device capable of performing black-pixel insertion comprising:
a first memory means for storing image data outputted to a pixel in each frame period;
a comparing means for receiving an Nth image data corresponding to images to be displayed by the pixel in an Nth frame period, accessing an (N-1)th image data corresponding to images displayed by the pixel in an (N-1)th frame period, and determining whether the Nth image data is different from the (N-1)th image data; and
a black-pixel insertion operating means for outputting the Nth image data to the pixel when the Nth image data is close to the (N-1)th image data, and outputting the Nth image data and a black image data to the pixel when the Nth image data is different from the (N-1)th image data.

10. The LCD device of claim 9 further comprising a second memory means for storing data of an over-drive voltage corresponding to an image data, wherein the black-pixel insertion operating means outputs data in accordance to the data stored in the second memory means.

11. The LCD device of claim 10 wherein the second memory means includes an electrically erasable programmable read-only memory (EEPROM).

12. The LCD device of claim 9 further comprising an image-generating means for generating the Nth image data and the (N-1)th image data.

13. The LCD device of claim 9 further comprising an image-generating means for generating the Nth image data, the (N-1)th image data and the black image data.
